(19) United States
(12) Patent Application Publication
(10) Pub. No.: US 2005/0265496 A1
(43) Pub. Date: Dec. 1, 2005

(54) Wireless system

(76) Inventors: Klas Johansson, SUNDBYBERG (SE); Johan Hultell Andersson, Solna (SE); Oskar Mauritz, Johanneshov (SE)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/526,396

(22) PCT Filed: Sep. 3, 2002
(86) PCT No.: PCT/IB02/03611

§ 371 Date: May 4, 2005

(51) Int. Cl. H04L 1/02; H04B 7/10; H04B 1/10; H04L 25/08

(52) U.S. Cl. 375/347; 375/348

(57) ABSTRACT

A receiver for use in a communications system, said receiver comprising a plurality of receiving means, at least two of said receiving means arranged to process the same signal received at different times; means for combining the output of at least two of said receiving means with different weights, said weights being arranged to take into account information relating to a spreading code of at least one signal other than said same signal.

### FIELD OF THE INVENTION

The present invention relates to a transmitting and receiving method, the transmitters and receivers, and in particular but not exclusively for use in a wireless communication system such as a cellular wireless system.

### BACKGROUND OF THE INVENTION

Wireless-cellular communication networks and their operation are generally well-known. In such a system the area covered by the network is divided into cells. Each cell is provided with a base station, which is arranged to communicate with a plurality of mobile stations or other user equipment in a cell associated with the base station.

In these known systems, a channel is typically allocated to each user. For example, in the case of a GSM (Global System for Mobile Communications) standard, a user is allocated a given frequency band and a particular time slot in that frequency band. A single information stream from a single user can be allocated a frequency band and time slot. The so-called third generation standards currently being proposed use code division multiple access (CDMA) methods to increase the capacity of each cell. In this standard each user is allocated a particular spreading code to define the user channel.

A transmission from point A to point B may take the direct path, but may also be reflected or diffracted by man made or natural phenomena objects such as buildings, large vehicles, and hills. This allows cellular communications to be used in complex and cluttered environments such as busy cities, where line of sight between transmitter and receiver is not usually possible. These types of environments are typically referred as multipath environments as the receiver receives several copies of the transmitted message from several distinct paths. The different lengths and the different number of reflections and diffractions mean that the various copies are received at different times and with different phases. A method proposed to improve the reception of a signal within a COMA channel is based on analyzing the different transmission paths in a communication channel. In this proposed system, the error rate is reduced by receiving and processing not only the signal transmitted over the main path, which is the strongest signal, but also weaker received signals transmitted over other transmission pathways. Within the receiver the signals received from other pathways are shifted in phase and in time and then added to the main received signal. Assuming that the time and phase shifts are accurate the summing of the received values produces a better signal to noise ratio than the single received main path signal.

An improvement on the simple summing of the received values has been proposed in the art. In this system the received signals are added together using a series of weights so that not all of the received signal values always have an equal importance in the final estimation. The estimation of these weights directly affects the accuracy of the estimation. Solutions for predicting these weights have been proposed. A conventional rake receiver modifies the weights dependent on measurements taken from the communications channel. In other words when a multiple path signal is detected, the conventional rake receiver estimates the delay and strength of each path. The receiver then combines all of the detected multiple path signals with a relative importance provided by the estimated strength of that path. The conventional receiver though does not provide particularly accurate results as it assumes that any interference received is uncorrelated in time—in other words that any interference is completely random and not linked to the transmitted signal.

The so-called generalized rake receiver improves on this as it takes the effect of some temporally correlated interference—in other words interference which is related to the signal—into account. One interference source accounted for is that created by multi-path fading—the interference created by a change in one or more of the transmitter, receiver or an object in the path of the signal. Another interference source allowed for in the generalized rake receiver is the interference created by the pulse shaping filters used to create the signal not having ideal characteristics. The generalized rake receiver allows for these types of interference by inserting extra rake fingers to monitor the signal received not only at the known multi-path tap periods but also close to these times. From these additional times it is possible to calculate combination weights tomaximize the signal to noise ratio for a particular user.

The generalized rake receiver uses the channel impulse response to calculate the weights. The generalized rake receiver assumes that on average the transmitted symbols will be uncorrelated. However if the symbols are considered on a symbol by symbol basis they are in fact correlated. This means that the results provided by the generalized rake receiver are not as accurate as they could be. Thus, in the generalized rake receiver the approximations made for the inter symbol interference, multi user interference, and intrinsic noise underestimate and ignore the effects created by code re-use and symbol differences. The generalized rake receiver approximations thus also ignore interference created between users and assume that codes used by different users are random and have no common elements.

A third type of receiver, the joint detector, approaches the solution of extraction of the signal from the multiple paths a different way. The Rake receiver approaches the problem by examining a single user and attempting to extract the message sent to the single user. In the process the multiple path signals for that user are extracted, processed and combined. The joint receiver instead receives signals not only from one user, or from one set of antennas, but for all users and antennas. The joint receiver then processes all of the received signals in order to be able to detect every user. In such a system the errors created by the other users, and from users outside the cell being currently used are compensated for. Such a system though is very complex, needing to explicitly require every user to be received and processed in order to receive and process a single user. The information required in order to use one of these receivers is usually not known by a mobile receiver. The introduction of such information increases the complexity and size of a mobile receiver, where the design of mobile handsets is usually aimed at simple and light receivers.

### SUMMARY OF THE INVENTION

It is the aim of the embodiments of the present invention to address or at least partially mitigate one or more of the problems discussed previously.

According to a first aspect of the present invention there is provided a receiver for use in a communications system, said receiver comprising a plurality of receiving means, at least two of said receiving means arranged to process the same signal received at different times; means for combining the output of at least two of said receiving means with different weights, said weights being arranged to take into account information relating to a spreading code of at least one signal other than said same signal.

According to a second aspect of the present invention there is provided a receiver for use in a communications system, said receiver having a plurality of receiving means, at leas two of said receiving means arranged to process the same signal received at different times; means for calculating the average correlation between a code of interest and n possible interfering-codes; means for combining the output of at least two of said receiving means with different weights, said weights being arranged to take into said average correlation.

According to a third aspect of the present invention there is provided a receiving method for us in a communications system, said method comprising, receiving with different receiving means the same received at different times; determining weights for outputs of said receiving means, said weights being arranged to take into account information relating to a spreading code of at least one signal other than said same signal; and combining the output of at least two of said receiving means with said weights.

According to a fourth aspect of the present invention there is provided a receiving method for use in a communications system, said method comprising the steps of calculating an average correlation between a code of interest and n possible interfering codes; and using said average correlation when determining weights for signal combination.

### BRIEF DESCRIPTION OF DRAWINGS

For a better understanding of the present invention and how the same may be carried into effect, reference will now be made by way of example only to the accompanying drawings in which:

FIG. 1 shows a schematic view of a typical cell layout of a cellular network, in which embodiments of the invention can be implemented;

FIG. 2 shows a Code Division Multiple Access (CDMA) wireless communication system in which embodiments of the present invention can be implemented;

FIG. 3 shows a schematic view of CDMA receiver circuitry;

FIG. 4 illustrates the function of the receiver circuitry of FIG. 3.

FIG. 5 shows the receiver circuitry of FIG. 3, in more detail.

FIG. 6 shows a weight estimator, embodying the present invention, of FIG. 5 in more detail.

FIG. 7 shows a graph of three different correlation metrics for aperiodic correlation function for a simulated spreading waveform where the time instants for each aperiodic correlation function are equal.

FIG. 8 shows the graph of three different correlation metrics for the aperiodic correlation function for a simulated spreading waveform where the time instants for each aperiodic correlation function are m and n and the relationship between m and n is m=n+2.

### DETAILED DESCRIPTION OF EMBODIMENTS OF THE PRESENT INVENTION

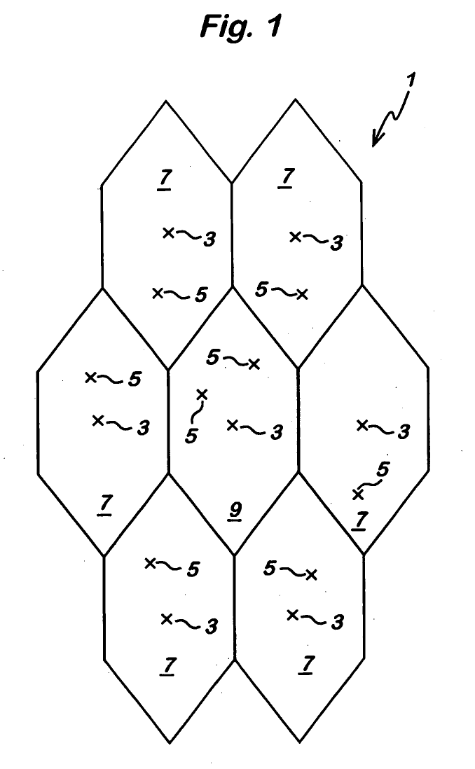

Reference is made to FIG. 1, which is part of a cellular telecommunications network 1 in which embodiments of the present invention can be implemented. The area covered by the network is divided into a plurality of cells 7,9. FIG. 1 shows a central cell 9 surrounded by six other cells 7. Further cells bordering these complete cells are not shown for clarity. Each cell has associated therewith a base transceiver station 3. The base transceiver station 3 is arranged to communicate with mobile devices or other user equipment 5 associated with the base transceiver station 3. Examples of mobile devices, include mobile telephones, Personal Digital Assistants (PDA) with transceiver capability, and laptops with transceiver capability. The cells may overlap at least partially or totally. In some systems, the cells may have different shapes to that illustrated. In some embodiments the base transceiver stations 3 may communicate with mobile devices 5 outside their associated cell. In other embodiments mobile devices 5 may communicate with mobile devices 5 directly and without recourse to the base transceiver station 3. In other embodiments of the invention base transceiver stations 3 may communicate with base transceiver stations 3 directly.

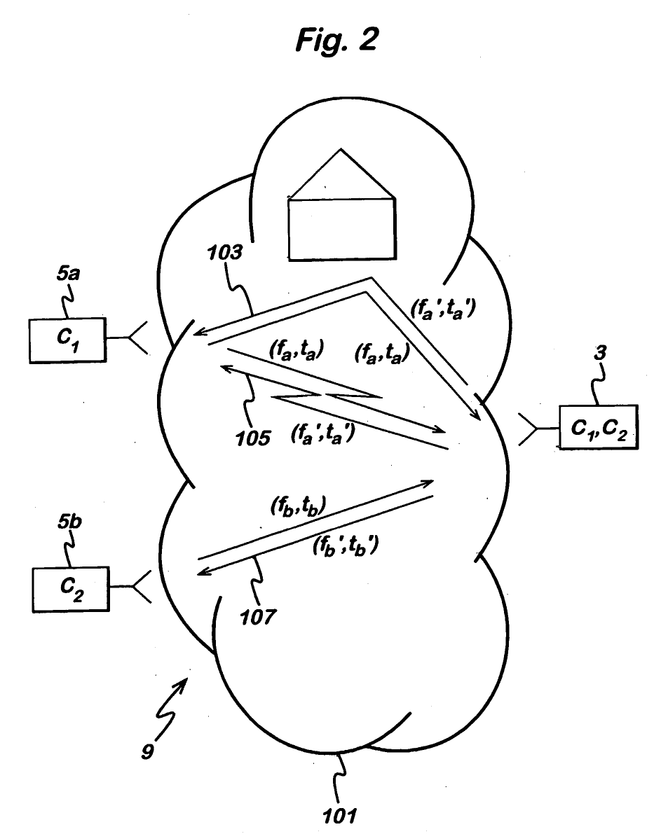

Reference is now made to FIG. 2, which shows one cell 9 of FIG. 1. The mobile devices 5a and 5b communicate with the base transceiver station 3 via the radio frequency environment 101. Mobile device 5a communicates with the base transceiver station 3 using a carrier frequency of fₐ and at time tₐ. Base transceiver station 3 communicates back to mobile device 5a using a carrier frequency of f_{a′} and at time t_{a′}. Mobile device 5b communicates with the base transceiver station 3 using a carrier, frequency of f_{b} and at time t_{b}. Base transceiver station 3 communicates back to mobile device 5b using a carrier frequency f_{b′} and at time t_{b′}. Within a Code Division Multiple Access (CDMA) system an attempt is made touse time slots as well as frequency bands efficiently due to the code orthogonality provided by Code Division Multiple Access system in such a system only one carrier frequency and time instant is used for the uplink and another carrier frequency/time pair is used for all downlinks. In other words fₐ=f_{b}, f_{a′}=f_{b′}, tₐ=t_{b} and t_{a′}=t_{b′}. For such a system the data signal to be transmitted is multiplied by a pseudo-random digital sequence known as a spreading code. This code has a much higher frequency or chip-frequency than the data sequence to be transmitted. The spreading code, which is a result of a cell specific scrambling code and a user specific channelization code, modulated waveform is then modulated to produce a radio-frequency waveform, which can then be transmitted. The different user signals are distinguished by their different spreading codes. The scrambling code is typically much longer than the spreading code. The scrambling code may be the same for all mobile devices served by the same base station. The different mobile devices served by the same base station would then be distinguished by different channelization codes, which are typically much shorter than the scrambling codes. Typically the scrambling code may be 38,400 chips long and the channelization code may be 16 chips long.

In a CDMA system each pair of mobile device 5 and base transceiver station 3 is assigned a separate-code. The codes are designed to be mutually orthogonal. In other words multiplying one code by another produces, in an ideal case (i.e. in a Additive White Gaussian Noise (AWGN) channel), a mean value of zero. Multiplying the code by itself, in an ideal case, produces a mean value equal to the value of the code. The maximum number of users that can use the same resource is determined by the channelization code of the spreading code, in some embodiments of the invention. In the following, reference to the spreading factor and spreading code is in fact referring to the channelization code. The use of the channelization code is advantageous in that it is relatively short and the required processing power can be provided relatively cheaply and easily. It should however be appreciated that in other embodiments of the present invention other parts of the code may be considered or indeed the entire code may be used. The spreading factor is the inverse of the ratio of the period of the spreading code divided by the period of the original signal. For example if the spreading factor was 16, the spreading code has a period or chip length 16 times smaller than the original signal. In other words the bandwidth of the spreading code is 16 times the original signal bandwidth.

The spreading factor N^{k} is the maximum number of users that can use the same resource and—in the ideal case—not have a code interfere with another user within one time slot. Another restriction, which implies that maximum number of users equals the spreading factor, is the fact that each user must uniquely separable. The codes are chosen in order not to interfere with each other, in other words are chosen to be orthogonal. If we consider the spreading code as a method of mapping the original signal in a N^{k} dimension space with co-ordinates provided by the spreading code the following can be seen. When N^{k=}1, only one user may be placed—in other words the signal is mapped into a 1 dimensional space where any additional users could not be placed. When N^{k=}2, two users can be placed—the signal is mapped into a 2-dimensional space where the first user and second users can be placed orthogonal to each other (if you consider the first user to be placed on the x axis and the second user on a y axis any additional user may by referenced as a combination of the first two users). This can be shown for positive integers greater than 2.

The transmitted waveforms may pass directly between transmitter and receiver as is shown by the transmission path 107 connecting the base transceiver station 3 to the mobile device 5b. This type of communication is known as line of sight and the path taken known as the line of sight path. The transmitted waveforms may pass from transmitter to receiver by a plurality of transmission paths. This plurality of paths is shown by pathways 103 and 105 between mobile device 5a and base transceiver station 3. These different paths occur when a transmission wave strikes an obstruction such as a building, a large vehicle or hillside. Whilst some of the transmission wave energy may be absorbed the remainder of the energy will be reflected by the object. This reflected wave may well go on and strike further objects and be further reflected. These reflected waves may also reach the receiver at which point they will arrive after the part of the wave which follows the line of sight path. As urban environments contain many more possible reflective objects, urban environments generally contain many more pathways from the transmitter to the receiver than the direct path. Also because of the density of reflective objects urban environments often contain areas where there is no line of sight pathway, only reflected pathways.

In some embodiments of the present invention more than one frequency/time pair is used for each uplink or downlink.

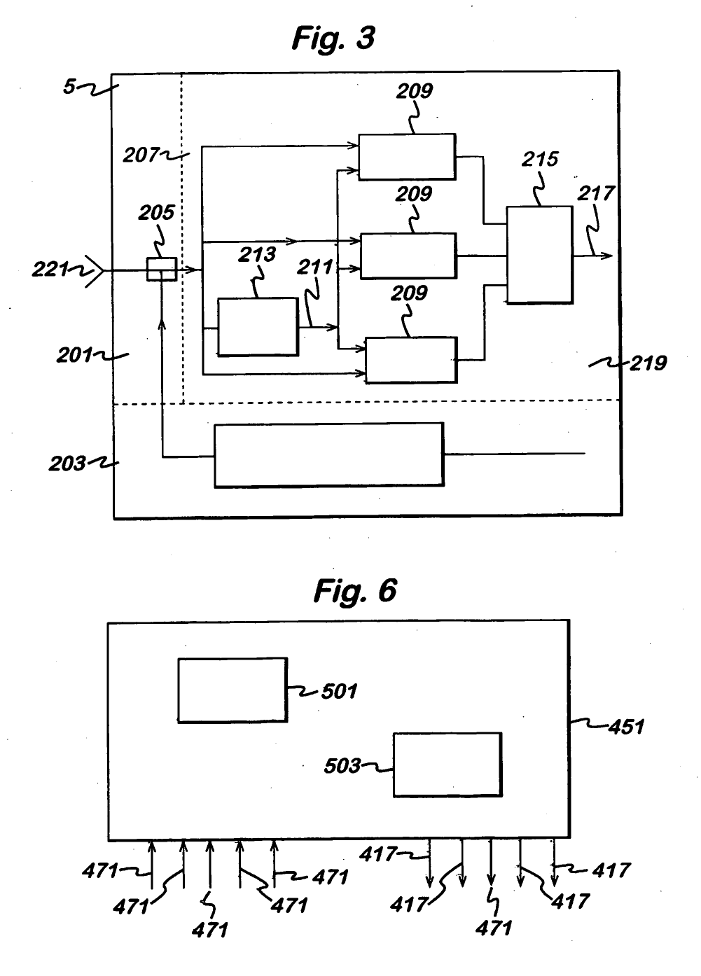

FIG. 3 shows a typical transceiver element within a mobile device 5. In other embodiments of the invention these transceiver elements are present in a base transceiver station 3. The transceiver comprises an antenna 221, a receiver 219, a transmitter 203 and a switch 205 connecting the antenna 221 to both the receiver 219 and transmitter 203. The method of transmission in COMA systems is well known and is not described further. The action of receiving and estimating a symbol value with a CDMA receiver will now be described in further detail.

The receiver 219, a rake receiver, comprises a RF link 207, a timing link 211, a timing analyzer 213, a series of rake fingers 209, and a summing device 215. The RF link receives radio frequency signals received by the antenna 221 and passed via the switch 205. The timing analyzer 213 receives the radio frequency received value on the RF connector 207. The timing analyzer produces a series of estimates of the multi-path environment 101 for the communications link being analyzed. These RF environment estimates are passed to each of the rake fingers 209 via the link 211. The rake fingers 209 also receive the radio frequency received values via the RF connector 207. Each rake finger 209 comprises circuitry to provide an estimate for a transmitted symbol for the strongest of the multiple transmission paths. This symbol value estimate is produced in dependence on the timing information passed to each rake finger 209 by the timing analyzer 213. Each rake finger 209 passes the symbol estimate to the summing device 215, which sums the symbol estimates to provide a soft symbol estimate 217.

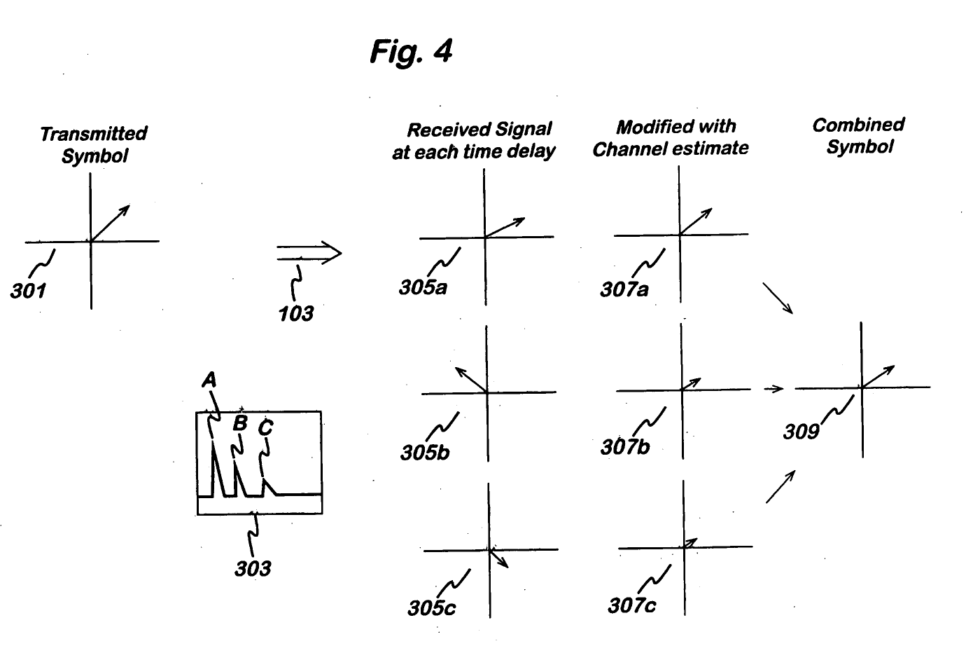

FIG. 4 illustrates the principle of the Rake receiver shown in FIG. 3. The transmitted signal 301 is transmitted over the transmission environment 101. Prior to this, or at the same time, a known timing symbol is transmitted in order to allow the timing analyzer 213 to estimate the number and properties of the multiple transmission paths 303A, 303B and 303C. This multiple path information is passed to the rake fingers 209. Each of the rake fingers extract the symbol estimate received at each of the times indicated by the timing analyzer 305A, 305B, 305C. A further level of processing is then carried out to modify the received symbols 305A, 305B and 305C with the known channel estimate produced by the timing analyzer 213 to produce estimated symbol values 307A, 307B and 307C. The modified symbols from each of the rake fingers 209 are then combined in the summing device 215 to produce a final symbol estimate 309.

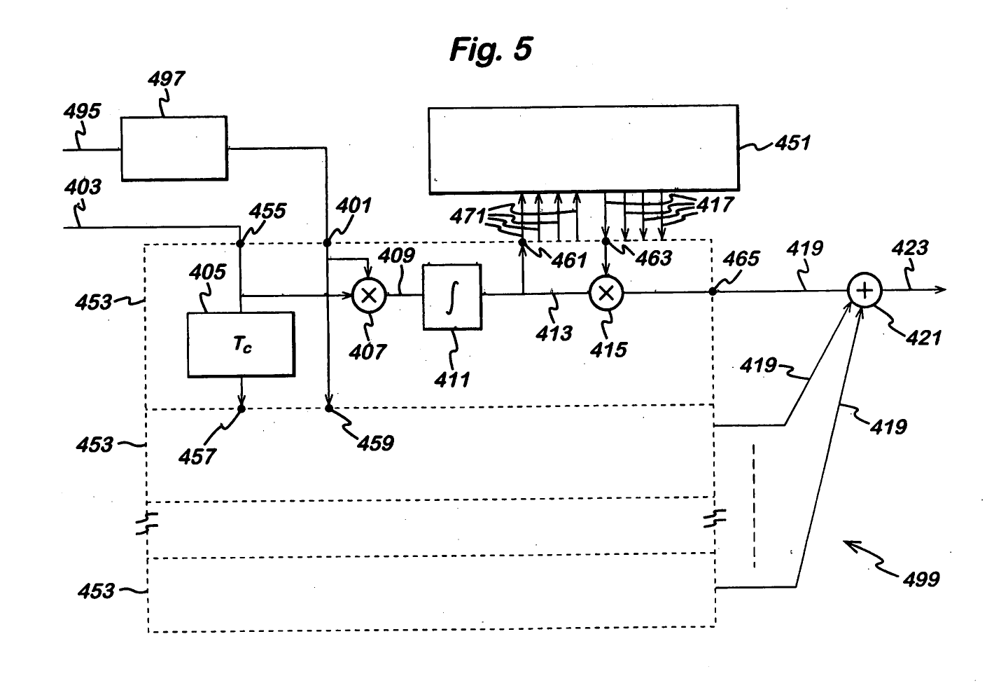

FIG. 5 shows a digital realization of a receiver for a CDMA system embodying the present invention. The receiver 499 comprises a radio frequency input 495, a demodulator 497, a series of rake fingers 453, a weight estimator 451, a spreading code input 403, and a summing device 421.

The radio frequency input 495 is connected to the input of the demodulator 497. The output of the demodulator is connected to the first (signal) input of the first rake finger 453.

The spreading code input 403 is connected to the second (code) input of the first rake receiver 453.

Each of the rake fingers 453, of which only the first is shown for clarity, comprises a first (signal) input 401, a second (code) input 455, a third (weight value) input 463, a first (signal) output 459, a second (code) output 457, a third (decorrelated value) output 461, a fourth (symbol value) output 465, a delay element 405, a first multiplier 407, an integrator 411, and a second multiplier 415. The first multiplier 407 and the integrator 411 define a correlator.

The rake fingers 453 are arranged so that the first (signal) output 459 of the n^{th} finger is connected to the first (signal) input 401 of the n+1^{th} finger. In a similar manner the second (code) output 457 of the n^{th} finger is connected to the second (code) input 455 of the n+1^{th} finger. Each of the rake fingers 453 is arranged so that the third (decorrelated value) output 461 is connected to the weight estimator 451 via signal lines 471. Each of the rake fingers 453 is arranged so that the third (weight value) input is connected to the weight estimator 451 via signal lines 417. Each of the rake fingers 453 is also arranged so that the fourth (symbol value) output 465 is connected to the summing device 421.

Each rake finger 453 is arranged so that the first (signal) input 401 is connected to the first input of the first multiplier 407 and also to the first (signal) output 459.

Each rake finger 453 is also arranged so that the second (code) input 455 is connected to the second input of the first multiplier 407 and also to the input of the delay unit 405. The output of the delay unit is connected to the second (code) output 457. The arrangement of adjacent rake fingers 453 is such that the n^{th} finger processes the spreading code from a time t_{c1}, whilst substantially simultaneously the n+1^{th} finger processes the spreading code from a chip code delayed t_{c1}−T_{c}.

The output of the first multiplier 407 is connected to the input of the integrator 411. The output of the integrator 411 is connected to the first input of the second multiplier 415 and the third (decorrelated value) output 461. The third (weight value) input 463 is connected to the second input of the second multiplier 415. The output of the second multiplier 415 is connected to the fourth (symbol value) output 465.

The first rake finger 453 is arranged so that the first (signal) input is connected to the output of the demodulator 497. The first rake finger is also arranged so that the second (code) input is connected to the spreading code data line 403.

The last rake finger 453 is arranged so that the first (signal) output is isolated, and the second (code) output is also isolated.

The weight estimator 451 receives a series of inputs on signal lines 471 each of which is connected to a different rake finger 453. The weight estimator 451 outputs a series of outputs on signal lines 417 each of which is connected to a different rake finger 453.

The summing device 421 receives a series of inputs on signal lines 419 each of which is connected to a different rake finger 453. The output of the summing device 421 is passed to the signal line 423.

The radio frequency input 495 passes the received signals to the demodulator, which outputs the baseband received signal r at a time instant t as defined in equation 1.

$$r ( t ) = {\sum }_{k = 0}^{{N}^{k} - 1} {\sum }_{l = 0}^{L - 1} {g}_{l}^{k} {x}^{k} ( t - {Δ}_{k} {T}_{c} - {τ}_{l}^{k} ) + n ( t ) \qquad ( 1 )$$

In equation 1 gₗ^{k} denotes the l^{th} channel tap for the user utilizing the k^{th} spreading code. In other words the wireless environment can be considered to act as a series of amplitude and phase modulating delay elements. The channel delay elements are connected in series so that a signal passes through each one. Each of these channel delay elements have an output which contributes to signal received at the receiver. The mathematical description of this model is usually called the channel impulse function.

The value of N^{k} is defined as the spreading factor. The spreading factor is also the maximum number of parallel channels taken into consideration. The spreading code chip period limits the possibilities of separating the separate paths of a channel. In embodiments of the present invention each active user has their own active spreading code. In other embodiments of the present invention each active user may have more than one active spreading code. In other embodiments of the present invention more than one user may share an active code. Therefore according to embodiments of the invention the number of active spreading codes may be more than, equal to, or less than the number of users sharing the transmission channel.

T_{c} in equation 1 is defined as the spreading code-chip period, i.e. the inverse of the code frequency. τₗ^{k} in equation 1 is defined as the channel delay of the l^{th} path for the k^{th} user. In equation 1 n(t) denotes the intercell interference at time t, ie the effect of transmissions from other cells, as well as the thermal noise. The value Δₖ defines the users time offset. For uplink communications Δₖ is typically non zero. The non zero user time offset is because, on communications from the mobile device 5 to the base transceiver station 3, the mobile devices 5 are not chip period synchronized and there is usually a small time difference between transmissions. For downlink communications Δₖ is assumed to be zero as the base transceiver station 3 broadcasts the same signal intended for all of the mobile devices 5 at the same time.

x^{k}(t) represents the transmitted baseband time-continuous signal for user k at time t, as is further defined with reference to equation 2 below.

Thus the received signal at time t is the sum of the delayed broadband time-continuous signal over all users over the delays from 0 to L−1 multiplied by the channel impulse characteristic for that user and time delay with an added thermal noise at time t element.

The transmitted baseband time-continuous signal x^{k}(t) at time t, i.e. the transmitted signal before it is modulated for transmission, can be written as equation 2.

$${x}_{k} ( t ) = \sqrt{2 {E}_{c}^{k}} {\sum }_{j} {s}^{k} [ j ] {a}^{k , j} ( t - {jN}^{k} {T}_{c} ) \qquad ( 2 )$$

The spreading waveform a^{k,j}(t) is the time continuous form of the spreading code signal applied to the digital signal s^{k}[j] and representing the k^{th} user and j^{th} symbol. The value \sqrt{2E_{c}^{k}} is a scaling value controlling the power of the pre-modulated signal. Thus the transmitted baseband time-continuous signal x(t) is defined as a power scaling value multiplied by the sum over all symbols j of a product of a symbol j and the time continuous spreading code for user k and symbol j.

The time continuous spreading waveform at time t can in turn be represented as the spreading code and its continuous time pulse response as seen in equation (3).

$${a}^{k , j} ( t ) = {\sum }_{m = 0}^{{N}^{k} - 1} {c}^{k} [ m , j ] {p}_{c} ( t - {mT}_{c} ) \qquad ( 3 )$$

The spreading code c^{k}[m, j] is the ma chip time instant of the spreading code for the k^{th} user and the j^{th} symbol. For simplicity of analysis it is assumed that the desired received response is for the initial symbol (j=0) from the user utilizing the first available code (m=0). The pulse response of the spreading code, or as it is also known the pulse shaping filter applied to the idealized spreading code, is represented by the p_{c}(t−mT_{c}) term.

The signal r(t) is passed into the rake finger 453, where it is multiplied by the spreading code for the required user. The arrangement of the rake fingers 453 is such that the demodulated received signal r(t) is passed to all rake fingers simultaneously, and therefore the first input of the rake fingers's 453 to the first multipliers 407. The added delay element 405 in each of the rake fingers 453 instead allows the second input of the first multiplier 407 of the rake fingers 453 to differ in that the spreading codes are one chip different from the adjacent code. In other words, the signals are delayed by one chip in successive rake fingers.

The output of the first multiplier 407 is passed on line 409 to the integrator 411. The integrator 411 receives the output from the first multiplier 407. It performs an averaging of the signal over a symbol period.

As described above the output of the correlator y(d_{f}), where the first symbol reception time instant is defined as d and f represents the rake finger number, is passed to the second multiplier 415.

The second multiplier multiplies the despread symbol output y(d_{f}) by a weight w_{f} provided by the weight estimator. This is passed to the summing device 421.

The output from the summing device 421 defines the decision statistic z, i.e. the best estimate of the original transmitted symbol. The relationship between the decision statistic z and the outputs of each of the rake fingers 453 is shown in equation 4

$$z = {\sum }_{f = 1}^{F} {w}_{f}^{*} y ( {d}_{f} ) = {w}^{H} y \qquad ( 4 )$$

where y=[y(d₁)y(d₂) . . . y(d_{F})]^{T} and w=[w₁, w,₂ . . . , w_{F}]^{T}. An alternate way to describe the output of the despread signal y is to split it into the desired symbol and noise components as shown in equation 5.
y=y_{d}s⁰[0]+y_{ISI}+y_{MUI}+ñ=y_{d}s⁰[0]+u (5)

Thus the despread signal is a combination of the desired signal y_{d}s⁰[0] i.e. the symbol s⁰[0] multiplied by a factor that in some sense represents the transmission path gain y_{d}. y_{d} also depends on the autocorrelation of the spreading waveform for the desired user. u represents the correlated Inter Symbol Interference (ISI) y_{ISI}, the correlated Multi User Interference (MUI) youth and other noise sources ñ. The inter symbol interference is the interference created by previous symbols which have been generated by the same user but, due to different length of the paths (i.e. multi-path transmission), enter the receiver simultaneously as the current symbol causing overlap with the current symbol. An example of this type of interference would be where the transmission path has many multi-paths of various lengths, and where the symbol length is short (i.e. the spreading factor is low). In such an example a first symbol following a very long path may arrive at the receiver at the same time as a second later symbol following a much more direct path. The impact of the inter symbol interference is decided by the autocorrelation function of the spreading waveform since the spreading codes are re-used during transmission. Optimally the spreading code should be described as white—i.e. they do not posses any temporal correlation—but because of the finite length of the spreading code this will not be possible causing inter symbol interference. Interpath interference may also be a problem. This is where the signals interfere before the signals reach the receiver.

Multi User Interference is generated from other users. An example of this occurs when two users from different cells re-use the same spreading code and the signals received from one user are not effectively cancelled. A more usual example is of two users whereby because of differences in transmission paths the first signal is not completely cancelled by the spreading code. This is only the case for downlink transmission as usually the users will have different channels in the uplink transmission.

An example of the another noise source is thermal noise generated internally within the electronic components because of the random motion of electrons in conductors. Together these noise sources can be combined and referenced as the overall interference u.

The aim of the weight estimator 451 is to choose a series of weight values to be output on the series of output lines 417 depending upon the decorrelated values stored on the series of input lines 471. The weight estimator unit 451 comprises a maximum likelihood detector as is known in the art for detecting the value of s⁰[0] given the observation vector y. This solution of the maximum likelihood detector may be represented mathematically by equation 6
w=Rᵤᵤ⁻¹y_{d} (6)

The covariance matrix of the overall interference, i.e. the time estimated value of the overall interference u multiplied by itself—E{uu^{H}} is defined as Rᵤᵤ. Y_{d} is the non symbol specific despread signal output at time instant d—in other words the received value divided by the expected symbol value. Assuming that the noise, Inter symbol Interference (ISI), and multi user interference (MUI), are independent the time averaged value of the overall interference can be rewritten as the time averaged values of the expected ISI R_{ISI}, MUI R_{MUI}, and other noise values Rₙ according to equation 7.
R=R_{ISI}+R_{MUI}+R_{ñ} (7)

The time averaged value of the Inter symbol interference R_{ISI} may be further expanded according to the previous equations as equation 8. In equation 8 d₁ and d₂ are two time instants. The value E_{c}⁰ is the power of transmitted symbol for user 0 (k=0). l and q are dummy variables to estimate the values over all combination of channel taps 0 to L−1, with channel characteristic given in gi and g_{q}. m and v are two dummy variables used to sum over the whole symbol period. Rₚ(q) is the auto correlation of the chip pulse at time instant q. C_{k,j}(m) is the aperiodic correlation function of the spreading sequence and is defined later in equation 12.

$${R}_{ISI} ( {d}_{1} , {d}_{2} ) = 2 {E}_{c}^{0} {\sum }_{l = 0}^{L - 1} {\sum }_{q = 0}^{L - 1} {g}_{l}^{0} {g}_{q}^{0} {\sum }_{j} {\sum }_{m = 1 - {N}^{k}}^{{N}^{k} - 1} {\sum }_{v = 1 - {N}^{k}}^{{N}^{k} - 1} {R}_{p} ( {d}_{1} - {jN}^{k} {T}_{c} - {τ}_{l}^{0} + {mT}_{c} ) \times {R}_{p} ( {d}_{2} - {jN}^{k} {T}_{c} - {τ}_{q}^{0} + {vT}_{c} ) E \{ {C}_{0 , j} ( m ) {C}_{0 , j} ( v ) \} \qquad ( 8 )$$

The time averaged value for the Multi User Interference R_{MUI} may similarly be derived from the previous equations to form equation 9.

$${R}_{MUI} ( {d}_{1} , {d}_{2} ) = {\sum }_{k = 1}^{{N}_{ac} - 1} 2 {E}_{c}^{k} {\sum }_{i = 0}^{L - 1} {\sum }_{q = 0}^{L - 1} {g}_{l}^{k} {g}_{q}^{k} {\sum }_{j} {\sum }_{m = 1 - {N}^{k}}^{{N}^{k} - 1} {\sum }_{v = 1 - {N}^{k}}^{{N}^{k} - 1} {R}_{p} ( {d}_{1} - {jN}^{k} {T}_{c} - {τ}_{l}^{k} + {mT}_{c} ) \times {R}_{p} ( {d}_{2} - {jN}^{k} {T}_{c} - {τ}_{q}^{k} + {vT}_{c} ) E \{ {C}_{k , j} ( m ) {C}_{k , j} ( v ) \} \qquad ( 9 )$$

The time averaged thermal noise Rn is also expanded in a similar way to form equation 10. The value No is known as the intrinsic noise power value.

$${R}_{\overline{n}} ( {d}_{1} , {d}_{2} ) = 2 {N}_{0} {\sum }_{m = 1 - {N}^{k}}^{{N}^{k} - 1} {C}_{0 , 0} ( m ) {R}_{p} ( {d}_{1} - {d}_{2} + {mT}_{c} ) \qquad ( 10 )$$

The vector y_{d} can also be rewritten using the previous equations to form equation 11.

$${y}_{d} ( {d}_{1} ) = \sqrt{2 {E}_{\overline{c}}^{0}} {\sum }_{i = 0}^{L - 1} {g}_{l}^{0} {\sum }_{m = 1 - {N}^{k}}^{{N}^{k} - 1} {C}_{0 , 0} ( m ) {R}_{p} ( {d}_{1} - {mT}_{c} - {τ}_{l}^{0} ) \qquad ( 11 )$$

In equations 8-11 above the aperiodic correlation function is defined as C_{k,j}(m). The aperiodic correlation function is the value produced by correlating two spreading sequences c^{k}[n,j], where k is the user number, j the symbol and n the number of chips into the j^{th} symbol and is defined by equation 12.

$${C}_{k , j} ( m ) = \{ \begin{matrix}{{\sum }_{n = 0}}^{{N}^{k} - 1 - m} {c}^{k} [ n , j ] {c}^{{0}^{*}} [ n + m , 0 ] & 0 \leq m \leq {N}^{k} - 1 \\ {\sum }_{n = 0}^{{N}^{k} - 1 + m} {c}^{k} [ n - m , j ] {c}^{{0}^{*}} [ n , 0 ] & 1 - {N}^{k} \leq m \leq 0\end{matrix} \qquad ( 12 )$$

Thus in order to calculate or estimate the weight function w it is necessary to have knowledge of the expected aperiodic correlation function for the spreading codes.

In the prior art of the generalized Rake receiver the values for the aperiodic correlation function are not calculated from received values but are found from a look up table. This is because the generalized Rake receiver does not know the spreading codes for other users. Therefore the table assumes that the expected spreading waveform aperiodic correlation function returns a value of zero when the two correlation functions are evaluated for the same user and symbol but at two different time instants m and v. This approximation is represented by equation 13.
E{C_{k,j}(m)C_{k,j}(v)}=0 when m≠v (13)

The look up table also assumes that when the spreading aperiodic correlation functions are taken at the same time, in other words that m=v, the following approximation rules apply.

$$E \{ {\vert {C}_{k , j} ( m ) \vert}^{2} \} = \{ \begin{matrix}0 & j = m = 0 , k \neq 0 \\ {( {N}^{k} )}^{2} & j = m = k = 0 \\ {N}^{k} - \vert m \vert & otherwise\end{matrix} \qquad ( 14 )$$

Therefore when the expected value of the aperiodic correlation function for spreading waveforms other than the required user and the symbol is equal to zero—the top line of the equation 14. The expected value of the aperiodic correlation function for the spreading waveforms for the required user at the correct symbol time produces a value of (N^{k})² which is equal to the square of the chip gain—the second line of equation 14. For all other cases, the expected value of the aperiodic correlation function is defined as the chip gain minus the absolute distance between the symbol instant and the measured instant—the final line of equation 14.

The look up table makes another assumption to produce a further approximation. The autocorrelation of the spreading waveform found in equation 10 is calculated using the approximation using the delta function as described in equation 15.
E{C_{0,0}(m)}=N^{k}δ[m] (15)

Thus when m=0, in other words the time instant of the expected symbol, the delta function returns a value of 1 and the expected autocorrelation value is equal to the chip gain, otherwise the delta function returns a value of zero and the expected autocorrelation value is equal to zero.

The generalized rake receiver approximations, equations 13-14, have to be made as the receiver, or part of the receiver used to estimate the initial user, contains only the spreading codes used by that user. These approximations therefore underestimate the effect of Multi user Interference.

The generalized rake receiver approximation made in equation 15 assumes that the expected aperiodic autocorrelation function is constant from symbol to symbol. This approximation underestimates the effect of Inter path interference.

In summary embodiments of the invention take into account the interference generated by other users by using additional knowledge of the spreading codes relating to other users in order to produce a more realistic estimate of the interference. In particular the interference from other active users in the same-cell as the user can be estimated by using knowledge of the spreading codes of other users.

Alternatively or additionally embodiments of the present invention are able to take into account the inter-symbol interference by making estimates of the values produced by a proceeding or a succeeding symbol.

In embodiments of the present invention, partial knowledge of interfering channelization codes can be used. For example, assuming that it is known that at least one out of four channelization codes are interfering, the average correlation between the code of interest and the four possible interfering codes can be calculated. This average correlation coefficient can then be used in the combining weights. In preferred embodiments of the present invention, it is not necessary to have complete knowledge of the interfering codes. This is different from the joint detector where you first have to estimate what codes are active.

Embodiments of the present invention are particularly applicable to TDD time division duplexing environments which use cyclically repeating short scrambling codes. Embodiments of the invention are particularly applicable to any suitable environment which use cyclically repeating short codes. The codes should be cyclically repeated in preferred embodiments of the present invention, but not necessarily, after for example a maximum of 75 symbols.

FIG. 6 shows the weight estimator 451 as used in embodiments of the invention. As described above the weight estimator comprises a series of inputs 471, a series of outputs 417, a signal estimator unit 501, and a weight estimator unit 503.

The weight estimator unit 503 receives inputs from the series of input lines 471 and the signal estimator unit 501. The signal estimator unit receives inputs from the series of input lines 471 and outputs values to the weight-estimator unit 503.

The aim of the weight estimator 451 is, as before, to choose a series of values to be output on the series of output lines 417 depending upon the values stored on the series of input lines 471. The weight estimator unit 503 comprises a maximum likelihood detector for s⁰[0] given the observation vector y.

The signal estimator unit 501 provides in embodiments of the invention the weight estimator unit with more accurate approximations of the active spreading sequences.

The signal estimator unit receives reference information from the received burst. As is known in the art the practical CDMA signal is broadcast as a series of bursts comprising a guard period, data period and a midamble period.

The midamble period is used to send training or pilot information for the receiver to aid reception of the symbol. The training or pilot information comprises information relating to the spreading codes of other users. The information can comprise the codes themselves, part of the codes, an index referring to which spreading codes are active within the cell or effective group of cells or the number of spreading codes which are active. Other parts of the transmission may in alternative embodiments of the present invention be used to provide this information.

The pilot sequence or training sequence is a reference-sequence known to the receiver and is used to provide information on the channel between the transmitter and receiver. In some embodiments of the invention this channel information comprises channel impulse information for the current user. In other embodiments of the present invention this information comprises channel impulse as well as spreading code information for users other than the current user. In further embodiments of the invention the pilot sequence or training sequence may include information on the pulse-shaping filter of the spreading code information in further embodiments of the present invention, the training sequence or pilot sequence may comprise transmitted power information.

This information comprising the spreading code information is used in embodiments to provide the following estimates for the aperiodic correlation function.

$$\hat{E} \{ {C}_{k , j} ( m ) {C}_{k , j} ( v ) \} = {\sum }_{i} {q}_{i} {C}_{i , j} ( m ) {C}_{i , j}^{*} ( v ) when m \neq v \qquad ( 16 )$$

and for the autocorrelation function

$$\hat{E} \{ {\vert {C}_{k , j} ( m ) \vert}^{2} \} = {\sum }_{i} {q}_{i} {\vert {C}_{i , j} ( m ) \vert}^{2} when m = v \qquad ( 17 )$$

In the above two approximations i is an index identifying the possible spreading waveforms. This information is provided from the reference signals. The weight of the i^{th} spreading waveform is defined as qᵢ. The weight of the i^{th} spreading waveform is derived from the channel response of the signal provided by the reference signal. The q values are calculated depending on the power of each interfering signal and are based on the channel estimates provided by the reference signal.

In a Time division duplex wideband COMA system (TDD-WCDMA), where different users are separated not only by spreading codes but by either spreading codes or time or a combination of both, a typical spreading code to symbol ratio is 16. A Frequency division duplex wideband CDMA system (FDD-WCDMA), where different users are separated not only by spreading codes but by spreading codes and/or frequency typically has a much greater chip to symbol ratio of 38400.

In embodiments of the present invention functioning within the TDD-WCDMA system, each symbol has a short chip period and it is therefore possible to calculate the different average aperiodic correlation function of the spreading sequence for each symbol. This calculation is more accurate than the approximation of the same function carried out by the generalized rake receiver where the correlation function approximation ignores the fact that the symbols differ. The additional information provided by the midamble of the signal is thus used to provide a better estimate of the correlation function. This is due to the short length of the channelization codes which means that the computation is not unduly complex or time consuming.

In the FDD-WCDMA system, each symbol has a long chip period. Calculating the average aperiodic autocorrelation function of the spreading sequence for each symbol in this case would involve a long delay from initially receiving the values to producing the result. Therefore in embodiments of the present invention the calculation of the average aperiodic correlation function of the spreading sequence may be carried out using the previous approximation in equation 15. Note that when the length of the spreading factor increases, the approximations presented in equation 15 becomes more valid due to the pseudo noise characteristics of the spreading codes.

Therefore in embodiments of the present invention operating within WCDMA systems where the chip period is small enough to calculate the average aperiodic correlation function for the whole symbol it is possible to calculate the value based upon the received value rather than an approximation. The inter path interference is compensated for by the explicit calculations.

The embodiments of the present invention are an improvement over the generalized rake receiver. The ability of the symbol estimator to detect a symbol is directly dependent on the ability to remove noise and interference from the received signal. This noise and interference suppression is achieved in the generalized rake receiver and embodiments of the present invention by the weight function applied to the rake finger's second multiplier. These weight functions are dependent upon the estimation of the interference and noise within the transmission environment. In the generalized rake receiver the approximations made for the inter symbol interference, multi user interference, and intrinsic noise underestimate and ignore the effects created by code re-use and symbol differences. The generalized rake receiver approximations also ignore interference created between users and that codes used by different users are random and have no common elements. Embodiments of the present invention estimate these effects using information passed to the receiver in the reference signals.

Therefore in embodiments of the present invention an improved estimate of the average interference is possible because of an improved estimate for the aperiodic correlation function and the autocorrelation function of the spreading codes. These estimates in embodiments of the invention are inserted into the correlation matrices described in equations 8, 9, and 10.

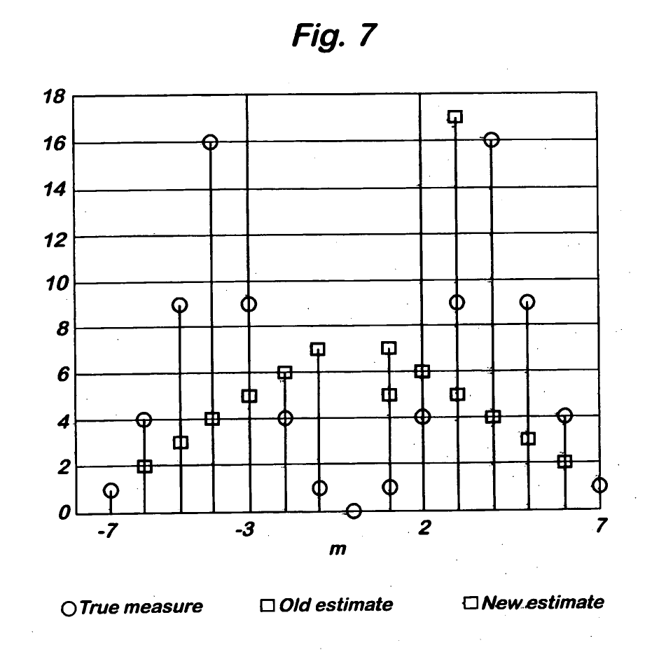

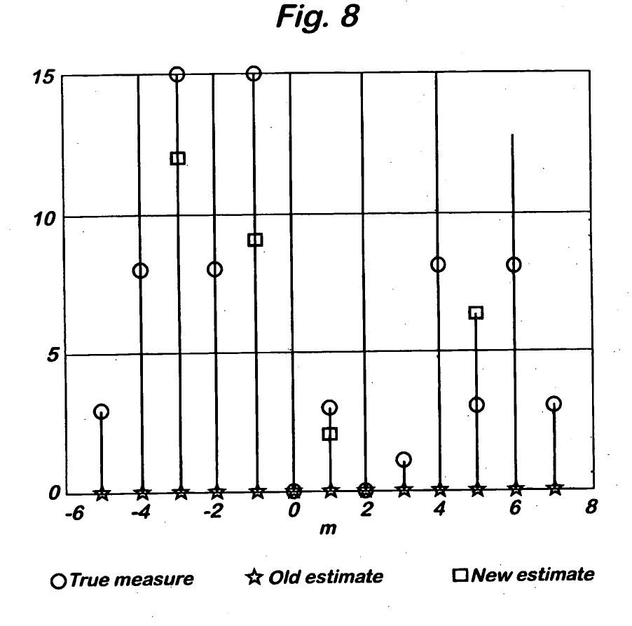

FIGS. 7 and 8 show examples of the improvement demonstrated by embodiments of the present invention. In such an example system there are eight parallel active codes and four different reference signals. Therefore there is not a one-to-one relationship between codes and reference signals. The true value of the cross correlation function in other words the correlation between two aperiodic correlation functions for all combinations of m and n—where m and n are the two time instants of the two spreading codes, with the time lag given by m−n can be referenced as

$${C}_{k , j}^{true} ( m - n ) .$$

The cross correlation function calculated by using the approximations provided by the generalized rake receiver in equations 13-15 is given by

$${C}_{k , j}^{prev} ( m - n ) .$$

The same cross correlation functions derived from embodiments of the present invention is given by

$${C}_{k , j}^{new} ( m - n ) .$$

All three cross functions have a length of 2N^{k}−1−Δ where Δ=m−n.

The error functions, in other words the errors between the expected true values and for the general rake receiver and the embodiment of the present invention is defined by equations 18 and 19 respectively.

$$\begin{matrix}{e}_{prev} ( m - n ) \hat{=} {( {C}_{k , j}^{prev} ( m - n ) - {C}_{k , j}^{true} ( m - n ) )}^{H} ( {C}_{k , j}^{prev} ( m - n ) - {C}_{k , j}^{true} ( m - n ) ) \\ and & ( 18 ) \\ {e}_{new} ( m - n ) \hat{=} {( {C}_{k , j}^{new} ( m - n ) - {C}_{k , j}^{true} ( m - n ) )}^{H} ( {C}_{k , j}^{new} ( m - n ) - {C}_{k , j}^{true} ( m - n ) ) . & ( 19 )\end{matrix}$$

An estimated average ratio can be defined according to equation 20.

$$E \{ \frac{{e}_{new}}{{e}_{prev}} \} = {\sum }_{k} {\sum }_{m - n = Δ} {\sum }_{m} \frac{{( {C}_{k , j}^{new} ( m - n ) - {C}_{k , j}^{true} ( m - n ) )}^{H} ( {C}_{k , j}^{new} ( m - n ) - {C}_{k , j}^{true} ( m - n ) )}{{( {C}_{k , j}^{prev} ( m - n ) - {C}_{k , j}^{true} ( m - n ) )}^{H} ( {C}_{k , j}^{prev} ( m - n ) - {C}_{k , j}^{true} ( m - n ) )} δ ( m - Δ - n ) \qquad ( 20 )$$

FIG. 7 shows a graph of the correlation metrics generated by the three different metric functions when Δ=0, in other words when the time instants are equal. For this example in embodiments of the present invention q-weights were taken as qᵢ=0.5 for both i=1 and 2. Estimating the average error metric using equation 20 gave the result of:—

$$E \{ \frac{{e}_{new}}{{e}_{prev}} \} = 0.5496$$

FIG. 8 shows a graph of the correlation metrics generated by the three different metric functions when Δ≠0, in other words when the time instants are not equal. The same q-weights were used as were used in the previous example. Once again estimating the average error metric using the equation 20 gives the result of:—

$$E \{ \frac{{e}_{new}}{{e}_{prev}} \} = 0.5360$$

From both FIGS. 7 and 8 and from the above average error metric it is clear that there is a marked improvement in embodiments of the present invention.

1. A receiver for use in a communications system, said receiver comprising:
a plurality of receiving means, at least two of said receiving means arranged to process the same signal received at different times;
means for combining the output of at least two of said receiving means with different weights, said weights being arranged to take into account information relating to a spreading code of at least one signal other than said same signal.

2. A receiver as claimed in claim 1, where in said information comprises one of: parts of codes used by said users, codes used by said users or information identifying codes used by said users, or number of active codes.

3. A receiver as claimed in claim 1, wherein said information is provided in a reference part of a signal.

4. A receiver as claimed in claim 1, wherein the information is provided by said same signal.

5. A receiver as claimed in claim 1, wherein said information further comprises information on a channel between said a transmitter transmitting said same signal and the receiver.

6. A receiver as claimed in claim 1, wherein said information on the channel comprises channel impulse response information.

7. A receiver as claimed in claim 1, wherein said information further comprises channel information for at least one other signal.

8. A receiver as claimed in claim 1, wherein said information further comprises information on a pulse shaping filter of the spreading code information.

9. A receiver as claimed in claim 1, wherein said information further comprises transmitted power information.

10. A receiver as claimed in claim 1, wherein the receiving means are arranged to process a symbol.

11. A receiver as claimed in claim 10, wherein the value of a preceding or succeeding symbol is estimated.

12. A receiver as claimed in 11, wherein the number of possible values of the preceding or succeeding symbol is dependent on a modulation method applied to said symbol.

13. A receiver as claimed in claim 1, wherein a first estimate is determined if the value of the succeeding or preceding part of the signal is the same as the current part of the signal and a second estimate is determined if the value of the succeeding or preceding part of the signal is different from the current part of the signal.

14. A receiver as claimed in claim 1, wherein intersymbol interference is estimated using the following equation:
$${R}_{ISI} ( {d}_{1} , {d}_{2} ) = 2 {E}_{c}^{0} {\sum }_{l = 0}^{L - 1} {\sum }_{q = 0}^{L - 1} {g}_{l}^{0} {g}_{q}^{0} {\sum }_{j} {\sum }_{m = 1 - {N}^{k}}^{{N}^{k} - 1} {\sum }_{v = 1 - {N}^{k}}^{{N}^{k} - 1} {R}_{p} ( {d}_{1} - {jN}^{k} {T}_{c} - {τ}_{l}^{0} + {mT}_{c} ) \times {R}_{p} ( {d}_{2} - {jN}^{k} {T}_{c} - {τ}_{q}^{0} + {vT}_{c} ) E \{ {C}_{0 , j} ( m ) {C}_{0 , j} ( v ) \}$$
where
R_{ISI} is the time averaged value of the Inter symbol interference between time instants d₁ and d₂, E^{o}_{c} is the value of the power of a single chip, g_{w} is the channel impulse function at time w, Rₚ(q) is the auto-correlation of the chip pulse at time instant q, and E{C_{0,j}(m)C_{0,j}(v)} is estimated value of the aperiodic auto correlation function of the spreading sequence for symbol j.

15. A receiver as claimed in claim 1, wherein multiuser interference is determined in accordance with the following equations:
$${R}_{MUI} ( {d}_{1} , {d}_{2} ) = {\sum }_{k = 1}^{{N}_{∝} - 1} 2 {E}_{c}^{k} {\sum }_{l = 0}^{L - 1} {\sum }_{q = 0}^{L - 1} {g}_{l}^{k} {g}_{q}^{k} {\sum }_{j} {\sum }_{m = 1 - {N}^{k}}^{{N}^{k} - 1} {\sum }_{v = 1 - {N}^{k}}^{{N}^{k} - 1} {R}_{p} ( {d}_{1} - {jN}^{k} {T}_{c} - {τ}_{l}^{k} + {mT}_{c} ) \times {R}_{p} ( {d}_{2} - {jN}^{k} {T}_{c} - {τ}_{q}^{k} + {vT}_{c} ) E \{ {C}_{k , j} ( m ) {C}_{k , j} ( v ) \}$$
where
R_{MUI} is the time averaged value of the multi-user interference between time instants d₁ and d₂, E^{k}_{c} is the value of the power of a single chip for user k, g^{k}w is the channel impulse function at time w for user k, Rₚ(q) is the auto-correlation of a chip pulse at time instant q, and E{C_{k,j}(m)C_{k,j}(v)} is an estimated value of an aperiodic auto correlation function of a spreading sequence for symbol j and user k.

16. A receiver as claimed in claim 1, wherein said signals received by said receiver comprise wanted signals and unwanted signals.

17. A receiver as claimed in claim 16, wherein said wanted and at least one of said unwanted signals are at the same frequency.

18. A receiver as claimed in claim 1, wherein said signals are code division multiple access signals.

19. A receiver as claimed in claim 1, wherein said receiver comprises a RAKE receiver.

20. A receiver as claimed in claim 1, wherein said receiving means comprise fingers.

21. A receiver as claimed in claim 1, wherein said signals are time division duplexing signals.

22. A receiver as claimed in claim 1, wherein said spreading codes comprising cyclically repeated codes.

23. A receiver as claimed in claim 1, wherein said codes are cyclically repeated after a maximum of 75 symbols.

24. A receiver as claimed in claim 23, wherein said codes are cyclically repeated after 16 symbols.

25. A receiver as claimed in claim 1, wherein said information comprises scrambling code information or channelization code.

26. A receiver as claimed in claim 1, wherein means are provided for calculating an average correlation between a code of interest and n possible interfering codes.

27. A receiver as claimed in claim 26, wherein said average correlation is used to determine said weights.

28. A receiver for use in a communications system, said receiver having a plurality of receiving means, at least two of said receiving means arranged to process the same signal received at different times;
means for calculating the average correlation between a code of interest and n possible interfering codes
means for combining the output of at least two of said receiving means with different weights, said weights being arranged to take into account said average correlation.

29. A receiving method for use in a communications system, said method comprising:
receiving with different receiving means the same signal received at different times;
determining weights for outputs of said receiving means, said weights being arranged to take into account information relating to a spreading code of at least one signal other than said same signal; and
combining the output of at least two of said receiving means with said weights.

30. A receiving method for use in a communications system, said method comprising the steps of:
calculating an average correlation between a code of interest and n possible interfering codes; and
using said average correlation when determining weights for signal combination.
